(19) United States
(12) Patent Application Publication
(10) Pub. No.: US 2007/0030374 A1
(43) Pub. Date: Feb. 8, 2007

(54) Electronic image capturing apparatus, control method of electronic image capturing apparatus, and image processing apparatus

(75) Inventor: Kensuke Ishii, San Diego, CA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/486,165

(22) Filed: Jul. 13, 2006

(30) Foreign Application Priority Data
Aug. 2, 2005 (JP) 2005-224193

(51) Int. Cl. H04N 5/222

(52) U.S. Cl. 348/333.01

(57) ABSTRACT

An electronic image capturing apparatus comprises an image sensor, a record section, a signal processing section and an electronic viewfinder. The image sensor is configured to capture a subject image. The record section is configured to record the image center area of the entire image area of an image signal output from the image sensor. The signal processing section is configured to convert the resolution of the entire image area of the image signal output from the image sensor. The electronic viewfinder is configured to display the resolution-converted image signal output from the signal processing section.

### CROSS-REFERENCE TO RELATED APPLICATIONS

This application is based upon and claims the benefit of priority from prior Japanese Patent Application No. 2005-224193, filed Aug. 2, 2005, the entire contents of which are incorporated herein by reference.

### BACKGROUND OF THE INVENTION

1. Field of the Invention

The present invention relates to an electronic image capturing apparatus which is used for capturing a moving picture, a control method thereof, and an image processing apparatus used in the electronic image Recapturing apparatus.

2. Description of the Related Art

In recent years, an electronic viewfinder has come to be used in an electronic image capturing apparatus. The electronic viewfinder displays an image captured by an image sensor for taking an actual recording image, allowing a user to visually confirm an actual image capturing range.

However, in an electronic image capturing apparatus for professional use which is used for shooting a movie, TV program, and the like, it is preferable that the viewfinder display also the area surrounding the actual image capturing area, like an optical viewfinder, to allow a camera operator to visually confirm the area outside the image capturing area. For example, the operator needs to configure (a recording screen of) an electronic image capturing apparatus so as not to capture a microphone that a sound man locates near a character or the like in accordance with the movement thereof. If, in such a case, the operator can visually confirm only the actual image capturing area, it is almost impossible to achieve such a configuration.

Jpn. Pat. Appln. Publication No. 5-83605 proposes a camera apparatus on which a user can visually confirm the area outside the image capturing area. In this camera apparatus, a capturing image is directly used as a display image on a viewfinder. At the output (recording) time, an image at, e.g., the center area is cut out from the capturing image, the obtained cutout image is then enlarged, and the enlarged image is output as an output image. With the above configuration, a camera operator can browse a viewfinder display image that covers a wider range than an image to be output (recorded) does.

### BRIEF SUMMARY OF THE INVENTION

According to a first aspect of the present invention, there is provided an electronic image capturing apparatus comprising:

an image sensor configured to capture a subject image;

a record section configured to record the image center area of the entire image area of an image signal output from the image sensor;

a signal processing section configured to convert the resolution of the entire image area of the image signal output from the image sensor; and

an electronic viewfinder configured to display the resolution-converted image signal output from the signal processing section.

According to a second aspect of the present invention, there is provided a control method of an electronic image capturing apparatus comprising:

recording the image center area of the entire image area of an image signal output from an image sensor configured to capture a subject image in a recording medium;

converting the resolution of the entire image area of the image signal output from the image sensor; and

displaying the resolution-converted image signal on an electronic viewfinder.

According to a third aspect of the present invention, there is provided an image processing apparatus comprising:

a recording image signal creation section configured to receive an image signal output from an image sensor configured to capture a subject image and output the image center area of the entire image area of the image signal as a recording image signal; and

a display image signal creation section configured to receive an image signal output from the image sensor and convert the resolution of the entire image area of the image signal so as to output it as a display image signal.

According to a fourth aspect of the present invention, there is provided an electronic image capturing apparatus comprising:

an image sensor for capturing a subject image;

record means for recording the image center area of the entire image area of an image signal output from the image sensor;

signal processing means for converting the resolution of the entire image area of the image signal output from the image sensor; and

an electronic viewfinder for displaying the resolution-converted image signal output from the signal processing means.

According to a fifth aspect of the present invention, there is provided a control method of an electronic image capturing apparatus comprising:

a step of recording the image center area of the entire image area of an image signal output from an image sensor configured to capture a subject image in a recording medium;

a step of converting the resolution of the entire image area of the image signal output from the image sensor; and

a step of displaying the resolution-converted image signal on an electronic viewfinder.

According to a sixth aspect of the present invention, there is provided an image processing apparatus comprising:

recording image signal creation means for receiving an image signal output from an image sensor configured to capture a subject image and outputting the image center area of the entire image area of the image signal as a recording image signal; and

display image signal creation means for receiving an image signal output from the image sensor and converting the resolution of the entire image area of the image signal so as to output it as a display image signal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of a camera which is an electronic image capturing apparatus according to a first embodiment of the present invention;

FIG. 2 is a view for explaining the resolutions of images output from respective sections;

FIG. 3 is a block diagram showing a configuration of a VF display image processing section;

FIG. 4 is a view for explaining operation of a resolution conversion section;

FIG. 5 is a view for explaining how a display image is displayed in an electronic viewfinder;

FIG. 6 is a view showing a flow of an image signal in a camera which is an electronic image capturing apparatus according to a second embodiment of the present invention;

FIG. 7 is a view showing a configuration of the camera according to the second embodiment;

FIG. 8 is a block diagram showing a configuration of a VF display image processing section;

FIG. 9 is a view for explaining sets of setting values used in setting a read method;

FIG. 10 is a view for explaining the resolutions of images output from respective sections in the case where a first setting values set is selected;

FIG. 11 is a view for explaining how pixels on an image sensor are used and how a display image is displayed in the electronic viewfinder in the case where the first setting values set is selected;

FIG. 12 is a view for explaining the resolutions of images output from respective sections in the case where a second setting values set is selected;

FIG. 13 is a view for explaining how pixels on an image sensor are used and how a display image is displayed in an electronic viewfinder in the case where the second setting values set is selected;

FIG. 14 is a view for explaining the resolutions of images output from respective sections in the case where a third setting values set is selected;

FIG. 15 is a view for explaining how pixels on an image sensor are used and how a display image is displayed in the electronic viewfinder in the case where the third setting values set is selected;

FIG. 16 is a view showing a relationship between the image sensor and electronic viewfinder in respective sets of setting values;

FIG. 17 is a view showing a flow of an image signal in a camera which is an electronic image capturing apparatus according to a third embodiment of the present invention;

FIG. 18 is a view showing a configuration of the camera according to the third embodiment;

FIG. 19A is a view for explaining the resolution of a read image when the low-speed mode is selected;

FIG. 19B is a view for explaining the resolution of a read image when the medium-speed mode is selected;

FIG. 19C is a view for explaining the resolution of a read image when the high-speed mode is selected;

FIG. 20 is a block diagram showing a configuration of a VF display image processing section in a camera which is an electronic image capturing apparatus according to a fourth embodiment of the present invention;

FIG. 21 is a view for explaining operation of a second resolution conversion section; and

FIG. 22 is a view showing a relationship between an image sensor and an electric viewfinder in the settings made by respective resolution conversion sections.

### DETAILED DESCRIPTION OF THE INVENTION

Preferred embodiments of the present invention will be described below with reference to the accompanying drawings.

### First Embodiment

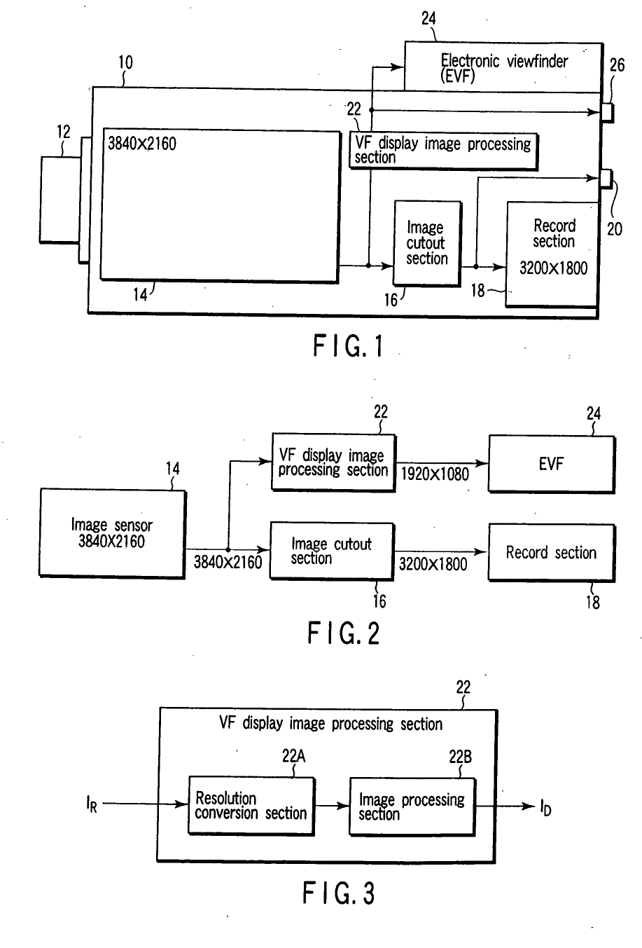

As shown in FIG. 1, a camera 10 which is an electronic image capturing apparatus according to a first embodiment of the present invention has a lens 12, an image sensor 14, an image cutout section 16, a record section 18, a recording image output terminal 20, a VF display image processing section 22, an electronic viewfinder (EVF) 24, and a display image output terminal 26. The lens 12 forms an optical image of a subject. The image sensor 14 captures an optical image of the subject formed by the lens 12. The image cutout section 16 cuts out an image center area as a recording image from an image signal read out from the image sensor 14. The record section 18 records a recording image cut out by the image cutout section 16 in a recording medium such as a tape or disk. The recording image output terminal 20 outputs the recording image cut out by the image cutout section 16 to an external recording apparatus. The VF display image processing section 22 applies resolution conversion to the entire image area of the image signal read out from the image sensor 14 to create a display image. The electronic viewfinder 24 displays a display image corresponding to the entire image area output from the VF display image processing section 22. The display image output terminal 26 outputs the display image output from the VF display image processing section 22 to an external display apparatus.

The resolution of the image sensor 14 is higher than that of the recording image as well as that of the electronics viewfinder 24. The image sensor 14 may be a single-plate image sensor, a four-plate image sensor of Bayer array type, or a three-plate type image sensor using a prism.

For example, as shown in FIG. 2, an electronic viewfinder having a resolution of 1920×1080 pixels which is equivalent to the resolution of Hi-Vision can be adopted as the electronic viewfinder 24, and an image sensor having a resolution of 3840×2160 pixels which is four times that of Hi-Vision can be used as the image sensor 14. In this case, when both ratios of horizontal and vertical EVF display pixels to recording pixels are designed at 120%, the resolution of a recording image becomes 3200×1800 pixels. The ratios of horizontal and vertical EVF display pixels to recording pixels are represented by the following expression, respectively:

Ratio (%) of horizontal EVF display pixels to recording pixels=(resolution of image sensor in horizontal direction/number of pixels of recording image in horizontal direction)×100; and

Ratio (%) of vertical EVF display pixels to recording pixels=(resolution of image sensor in vertical direction/number of pixels of recording image in vertical direction)×100.

In the camera 10 having the configuration described above, the image cutout section 16 cuts out an image center area corresponding to an image signal of 3200×1800 pixels from the image signal captured at a resolution of 3840×2160 pixels by the image sensor 14 as a recording image. The image cutout section 16 may only cut out an image or may additionally perform ordinary image processing such as Bayer interpolation (only in the case where a Bayer array type image sensor is used) or color image processing. The image cutout section 16 then records the cut out recording image having a resolution of 3200×1800 pixels in the record section 18 or outputs the recording image to a not shown external recording apparatus through the recording image output terminal 20.

The VF display image processing section 22 applies resolution conversion to the entire image area of the image signal that the image sensor 14 has captured at a resolution of 3840×2160 pixels to create a display image having a resolution of 1920×1080 pixels. The VF display image processing section 22 then displays the created display image having a resolution of 1920×1080 pixels on the electronic viewfinder 24 or outputs the display image to a not shown external display apparatus through the display image output terminal 26.

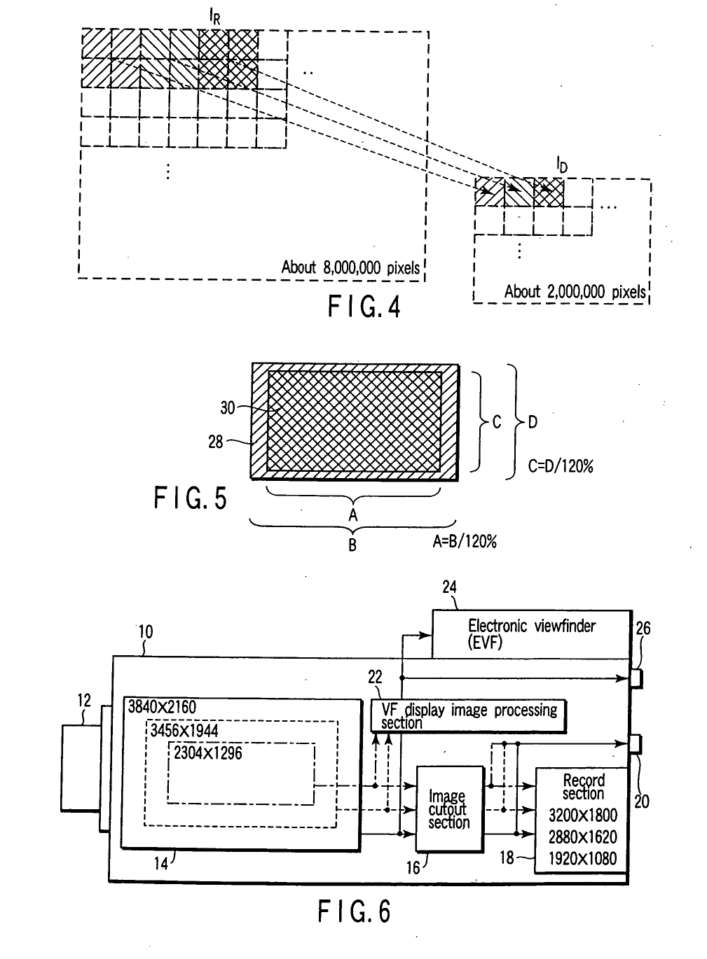

As shown in FIG. 3, the VF display image processing section 22 includes a resolution conversion section 22A which converts the resolution of a read image I_{R} read from the image sensor 14 to obtain a display image I_{D}. The resolution conversion section 22A can be realized by, e.g., a DSP. Assuming that the resolutions of the image sensor 14 and electronic viewfinder 24 are as described above, the resolution conversion section 22A calculates one pixel of the display image I_{D} from 2×2 pixels of the read image I_{R} to thereby reduce the resolution of the display image I_{D} to ¼ the resolution of the read image I_{R}, as shown in FIG. 4. The above calculation may be performed, e.g., by taking the average of four pixels. However, the calculation method for reducing resolution is not limited to this in the present embodiment, and a technique widely used in the field of the image processing can appropriately be adopted.

Though the resolution conversion processing performed by the resolution conversion section 22A, the display image is displayed in the electronic viewfinder 24 as shown in FIG. 5. That is, the entire image area being captured by the image sensor 14 is displayed in an image display area 28 corresponding to the entire display area of the electronic viewfinder 24. A recording area 30, which is an actual output (recording) area, is located at the center area of the image display area 28. In this case, the height and width of the image display area 28 is 120% of the that of the recording area 30.

When the camera 10 is actually used, the recording area 30 needs to be identified by a camera operator. In the present embodiment, therefore, an image processing section 22B is provided in the VF display image processing section 22. The image processing section 22B adds, to the display image I_{D} whose resolution has been converted by the resolution conversion section 22A, an indication for presenting the recording area 30 which is an actual output (recording) area to the camera operator. For example, the image processing section 22B displays a frame surrounding the recording area 30 on the display image I_{D} in a superimposed manner. Alternatively, the image processing section 22B may give a difference in brightness between the inside and outside of the recording area 30, or display the inside area of the recording area 30 in colors and outside area thereof in monochrome. Any other processing may be applied as long as the camera operator can identify the recording area 30.

As described above, in the camera 10 according to the first embodiment, only an image center area is selected from the image read out from the image sensor 14 and recorded in the record section 18. As a result, it is possible to record a taken image without degrading its image quality. Further, the recording area 30 requires less storage area.

Further, the entire image that has been compressed by the VF display image processing section 22 is sent to the electronic viewfinder 24 and, thereby, the camera operator can visually confirm the outside area of the image to be recorded in the record section 18. Since the outside area of the image to be recorded is displayed on the electronic viewfinder 24, the camera operator can easily capture a subject and easily adjust the camera's angle of view.

Further, since the camera 10 is provided with the recording image output terminal 20, it is possible to output the recording image to an external apparatus for large data recording.

Further, since the camera 10 is provided with the display image output terminal 26, it is possible to output the display image I_{D} identical to the image on the electronic viewfinder 24 for displaying it on a larger screen. Further, the display image I_{D} output from the display image output terminal 26 can be recorded in a recording medium.

### Second Embodiment

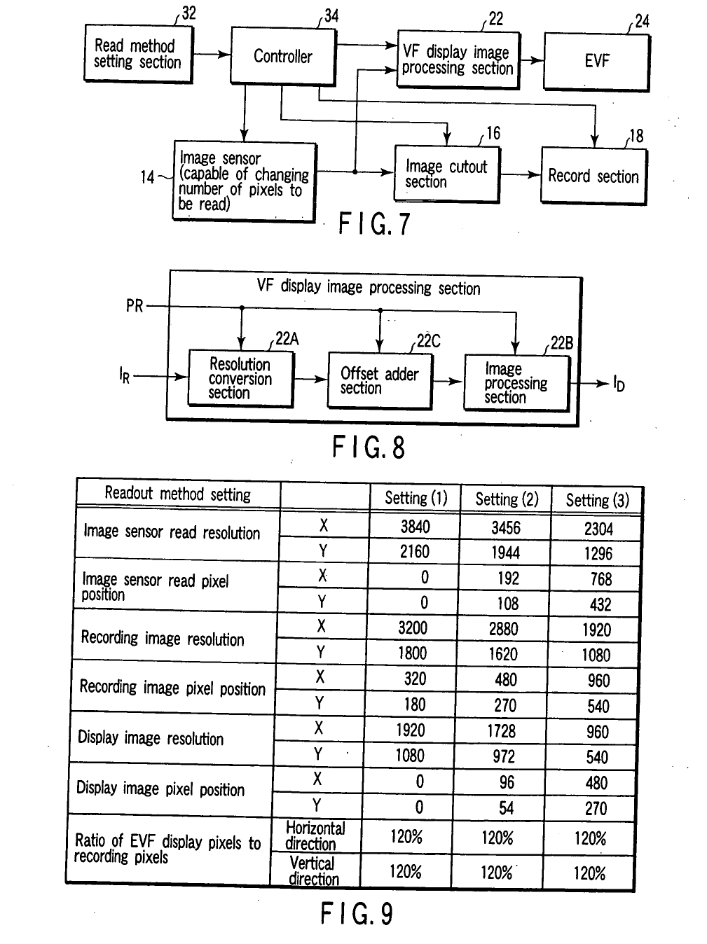

The camera 10, which is an electronic image capturing apparatus according to a second embodiment of the present invention, uses an image sensor capable of changing the number of pixels to be read, such as a CMOS sensor, as the image sensor 14 that captures an optical image of a subject formed by the lens 12. As shown in FIGS. 6 and 7, in addition to the configuration of the first embodiment, the camera 10 according to the present embodiment has a read method setting section 32 for setting a read method and a controller 34 which controls the image sensor 14, image cutout section 16, record section 18, and VF display image processing section 22 according to the setting made in the read method setting section 32. Further, as shown in FIG. 8, in addition to the configuration of first embedment, the VF display image processing section 22 has an offset adder section 22C.

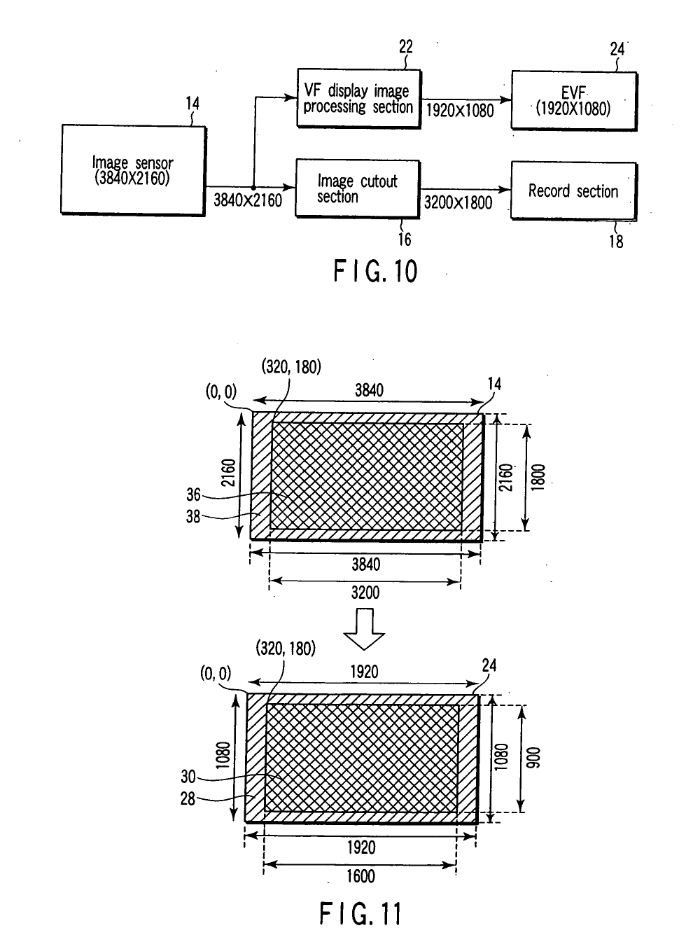

The read method setting section 32 sets a read method according a camera operator's operation using dedicated buttons or using selection buttons for an on-screen menu displayed on the electronic viewfinder 24. Items to be set in the read method include a read resolution for the image sensor 14 and pixel position thereon, a read resolution for the recording image and pixel position thereon, a read resolution for the display image ID and pixel position thereon, ratios of EVF display pixels to recording pixels, and the like. The operator may set the above items one by one, or, as shown in FIG. 9, may select one set from several sets of setting values that have previously been stored. FIG. 9 shows an example in which the resolution of the image sensor 14 is set to 3840×2160 pixels, and resolution of the electronic viewfinder 24 is set to 1920×1080 pixels.

As shown in FIGS. 10 and 11, when a first setting values set is selected, the controller 34 reads an image of 3840×2160 pixels starting from a pixel position (0, 0) on the image sensor 14 and inputs the read image to the image cutout section 16 and VF display image processing section 22. At the same time, the controller 34 gives, as a read method setting parameter PR, information related to the offset position and resolution to the image cutout section 16 and allows the image cutout section 16 to cut out an image of 3200×1800 pixels starting from a pixel position (320, 180) on the read image I_{R}. Then, the controller 34 gives, as a read method setting parameter PR, information related to the resolution to the record section 18 and allows the record section 18 to record the cutout image at a resolution of 3200×1800 pixels as a recording image. Further, the controller 34 gives, as a read method setting parameter PR, information related to the offset position, resolution, and ratios of EVF display pixels to recording pixels to the VF display image processing section 22. The resolution conversion section 22A of the VF display image processing section 22 compresses (performs resolution conversion of) the read image I_{R} to an image of a resolution of 1920×1080 pixels and then the offset adder section 22C adds an offset to the compressed image. However, since the display image pixel position is set to X=0, Y=0 in the first setting values set, the compressed image is not offset, but the entire image corresponding to 1920×1080 pixels starting from a pixel position (0, 0) on the display area of the electronic viewfinder 24 is set as the image display area 28. The image processing section 22B then applies image processing to the display image I_{D} so that the recording area 30 having a size specified by the ratios of EVF display pixels to recording pixels can be identified by a camera operator and displays the processed image on the electronic viewfinder 24. In this case, the recording area 30 has a size of 1600×900 pixels on the electronic viewfinder 24. Viewed from the image sensor 14, as shown in FIG. 11, an area having 3200×1800 pixels of the entire area having 3840×2160 pixels of the image sensor 14 is a pixel area 36 used for both EVF display and recording, and residual area is a pixel area 38 used only for EVF display.

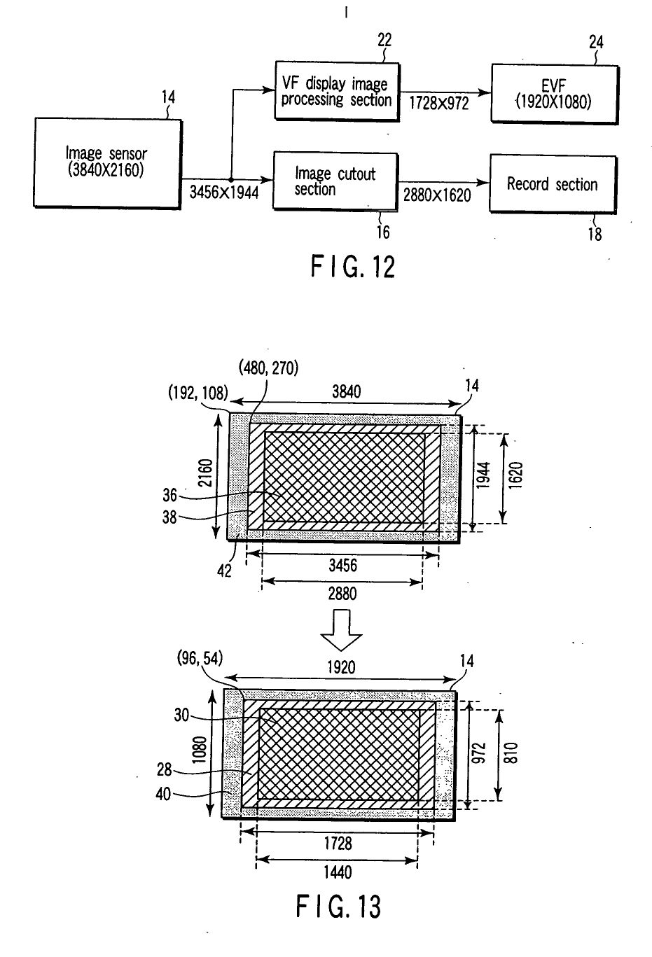

As shown in FIGS. 12 and 13, when a second setting values set is selected, the controller 34 reads out an image of 3456×1944 pixels starting from a pixel position (192, 108) on the image sensor 14 and inputs the read image to the image cutout section 16 and VF display image processing section 22. At the same time, the controller 34 gives, as a read method setting parameter PR, information related to the offset position and resolution to the image cutout section 16 and allows the image cutout section 16 to cut out an image of 2880×1620 pixels starting from a pixel position (288, 162) on the read image I_{R} which corresponds to a pixel position (480, 270) with respect to a pixel position (0, 0) on the image sensor 14. Then, the controller 34 gives, as a read method setting parameter PR, information related to the resolution to the record section 18 and allows the record section 18 to record the cutout image at a resolution of 2880×1620 pixels as a recording image. Further, the controller 34 gives, as a read method setting parameter PR, information related to the offset position, resolution, and ratios of EVF display pixels to recording pixels to the VF display image processing section 22. The resolution conversion section 22A of the VF display image processing section 22 compresses (performs resolution conversion of) the read image I_{R} to an image of a resolution of 1728×972 pixels and then the offset adder section 22C adds an offset to the compressed image. Since the pixel position on the display image I_{D} is set to X=96, Y=54 in the second setting values set, the offset adder section 22C adds an offset corresponding to the above coordinate position with respect to a position (0, 0) on the display area of the electronic viewfinder 24. As a result, an image having a size of 1728×972 pixels and starting from a pixel position (96, 54) on the display area of the electronic viewfinder 24 is set as the image display area 28. The image processing section 22B then applies image processing to the display image I_{D} so that the recording area 30 having a size specified by the ratios of EVF display pixels to recording pixels can be identified by a camera operator and displays the processed image on the electronic viewfinder 24. In this case, the recording area 30 has a size of 1440×810 pixels on the electronic viewfinder 24. At this time, the image processing section 22B applies image processing to the residual area of the display area on the electronic viewfinder 24 such that, for example, a mask pattern 40 such as a black image is displayed on the residual area. Note that an unused pixel area 42 on the image sensor 14 in FIG. 13 is the area from which an image is not read.

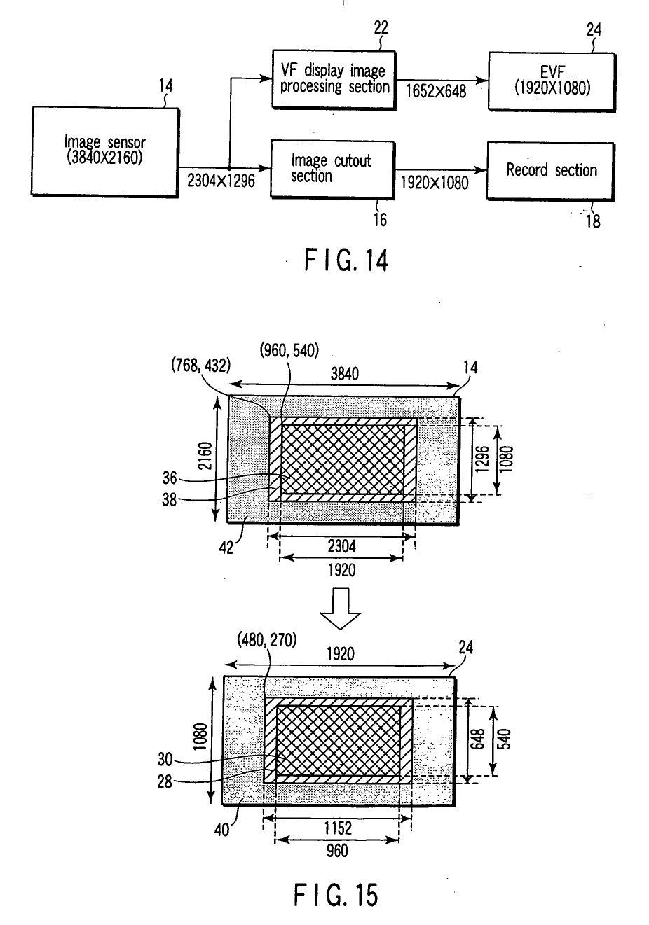

As shown in FIGS. 14 and 15, when a third setting values set is selected, the controller 34 reads an image of 2304×1296 pixels starting from a pixel position (768, 432) on the image sensor 14 and inputs the read image to the image cutout section 16 and VF display image processing section 22. At the same time, the controller 34 gives, as a read method setting parameter PR, information related to the offset position and resolution to the image cutout section 16 and allows the image cutout section 16 to cut out an image of 1920×1080 pixels starting from a pixel position (192, 108) on the read image I_{R} which corresponds to a pixel position (960, 540) with respect to a pixel position (0, 0) on the image sensor 14. Then, the controller 34 gives, as a read method setting parameter PR, information related to the resolution to the record section 18 and allows the record section 18 to record the cutout image at a resolution of 1920×1080 pixels as a recording image. Further, the controller 34 gives, as a read method setting parameter PR, information related to the offset position, resolution, and ratios of EVF display pixels to recording pixels to the VF display image processing section 22. The resolution conversion section 22A of the VF display image processing section 22 compresses (performs resolution conversion of) the read image I_{R} to an image of a resolution of 1652×648 pixels and then the offset adder section 22C adds an offset to the compressed image. Since the pixel position on the display image I_{D} is set to X=480, Y=270 in the third setting values set, the offset adder section 22C adds an offset corresponding to the above coordinate position with respect to a position (0, 0) on the display area of the electronic viewfinder 24. As a result, an image having a size of 1652×648 pixels and starting from a pixel position (480, 270) on the display area of the electronic viewfinder 24 is set as the image display area 28. The image processing section 22B then applies image processing to the display image I_{D} so that the recording area 30 having a size specified by the ratios of EVF display pixels to recording pixels can be identified by a camera operator and displays the processed image on the electronic viewfinder 24. In this case, the recording area 30 has a size of 960×540 pixels on the electronic viewfinder 24. At this time, the image processing section 22B applies image processing to the residual area of the display area on the electronic viewfinder 24 such that, for example, a mask pattern 40 such as a black image is displayed on the residual area.

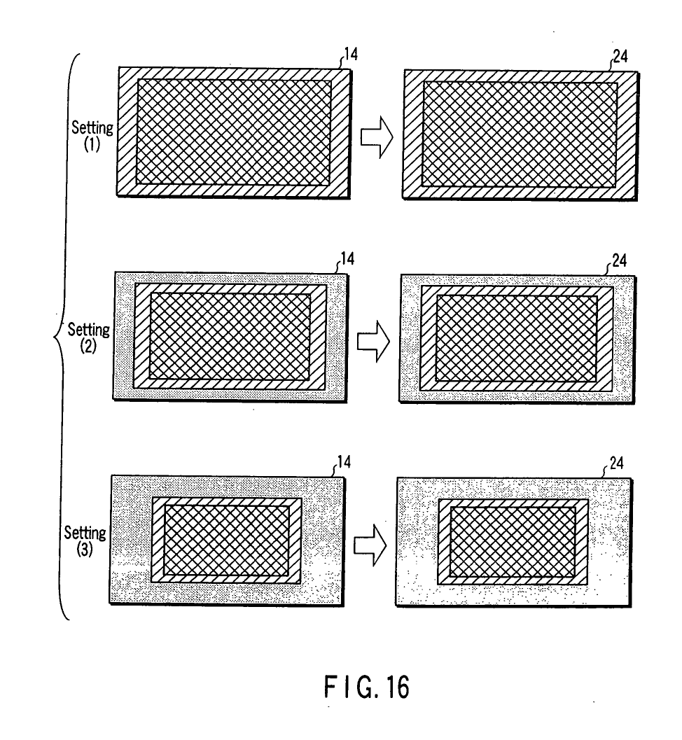

A relation between the image sensor 14 and electronic viewfinder 24 in respective sets of setting values is summarized in FIG. 16. As shown in FIG. 16, in any set of setting values, although the resolution between the read image I_{R} read from the image sensor 14 and display image I_{D} displayed on the electronic viewfinder 24 is changed (¼), the positional relationship between them is maintained. Similarly, the positional relationship between the read image I_{R} read from the image sensor 14, the display image I_{D} displayed on the electronic viewfinder 24 and recording image to be recorded in the record section 18 is maintained.

As described above, according to the second embodiment, an electronic image capturing apparatus capable of setting an arbitrary read method and arbitrary electronic viewfinder display method can be provided.

Although the ratios of horizontal and vertical EVF display pixels to recording pixels are the same between the setting values sets, they may differ from one another. Further, the camera operator him or herself may change the ratios of EVF display pixels to recording pixels depending on a subject or scene to be shot on a case-by-case basis. Further, individual setting items in the setting values set may be arbitrarily set.

When the resolution of the recording image is made changeable, it is possible to change the length of time (capturing time) that can be recorded in a recording medium or amount of the data to be transferred to a postproduction stage.

### Third Embodiment

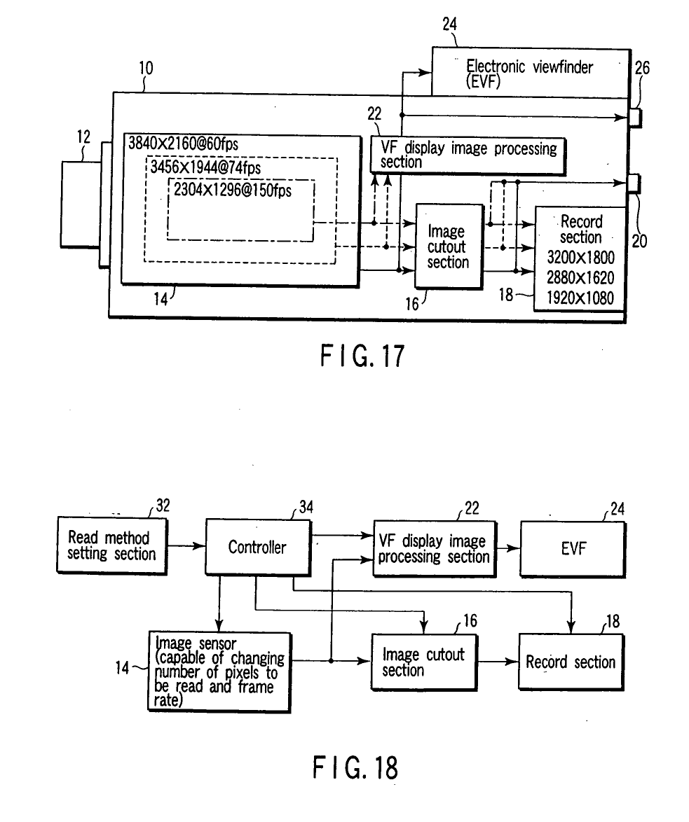

As shown in FIGS. 17 and 18, the camera 10, which is an electronic image capturing apparatus according to a third embodiment of the present invention, has the same configuration as that of the second embodiment. Only a different point is that an image sensor capable of changing the number of pixels to be read and a frame rate is used as the image sensor 14 for realizing slow-motion capturing or special effect capturing. Therefore, items to be set in the read method setting section 32 in the present embodiment include a read resolution, pixel position and frame rate for the image sensor 14, a read resolution for the recording image and pixel position thereon, a read resolution for the display image I_{D} and pixel position thereon, ratios of EVF display pixels to recording pixels, and the like.

In this case, it is necessary to decrease the resolution of the recording image as the frame rate is increased, in consideration of limitation of the allowable recording speed (recording capability) of the record section 18. In order to cope with this, the following processing are performed depending on the frame rate in the present embodiment.

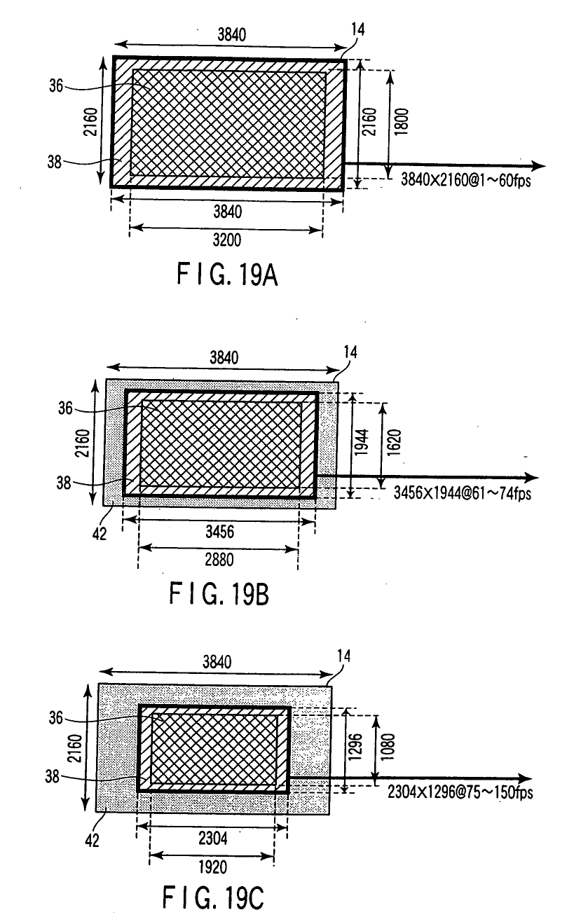

When the low-speed mode in which the frame rate falls in a range from 1 to 60 fps is selected, an image of 3840×2160 pixels is read, as the read image I_{R}, starting from a pixel position (0, 0) on the image sensor 14 at the set frame rate, as shown in FIG. 19A. Then, an image corresponding to a resolution of 3200×1800 pixels is cut out from the read image I_{R} and recorded in the record section 18. The entire read image I_{R} of 3840×2160 pixels is displayed on the electronic viewfinder 24 at a resolution of 1920×1080 pixels.

When the medium-speed mode in which the frame rate falls in a range from 61 to 74 fps is selected, an image of 2304×1296 pixels is read, as the read image I_{R}, starting from a pixel position (768, 432) on the image sensor 14 at the set frame rate, as shown in FIG. 19B. Then, an image corresponding to a resolution of 2880×1620 pixels is cut out from the read image I_{R} and recorded in the record section 18. The entire read image I_{R} of 2304×1296 pixels is displayed on the electronic viewfinder 24 at a resolution of 1728×972 pixels.

When the high-speed mode in which the frame rate falls in a range from 75 to 150 fps is selected, an image of 3840×2160 pixels is read, as the read image I_{R}, starting from a pixel position (0, 0) on the image sensor 14 at the set frame rate, as shown in FIG. 19C. Then, an image corresponding to a resolution of 1920×1080 pixels is cut out from the read image I_{R} and recorded in the record section 18. The entire read image I_{R} of 3840×2160 pixels is displayed on the electronic viewfinder 24 at a resolution of 1652×648 pixels.

As described above, according to the third embodiment, a variable frame rate type electronic image capturing apparatus can be provided.

### Fourth Embodiment

The camera 10, which is an electronic image capturing apparatus according to a fourth embodiment of the present invention, has the same configuration as that of the second embodiment except for the configuration of the VF display image processing section 22.

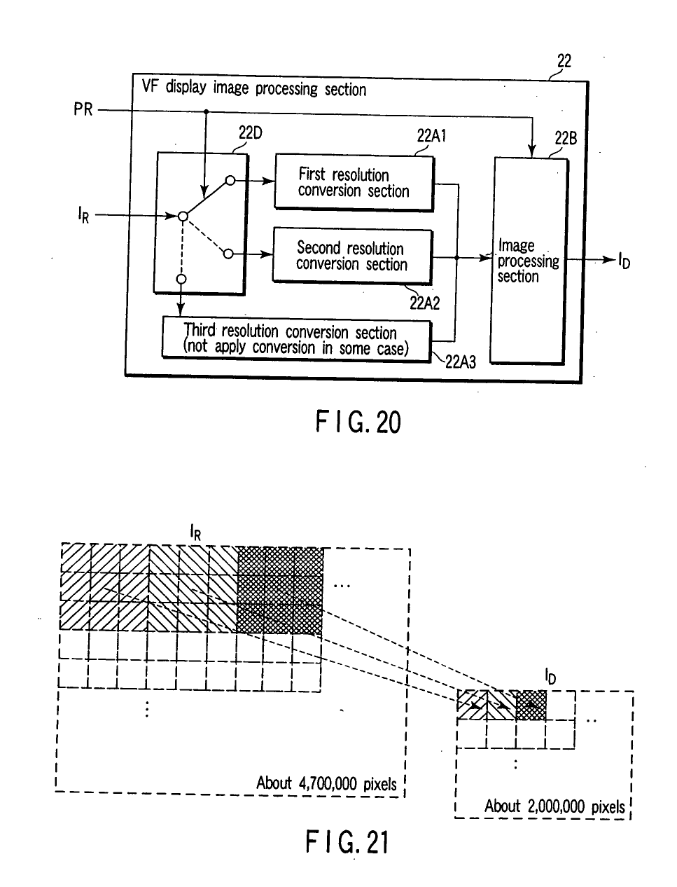

More specifically, while the VF display image processing section 22 of the second embodiment has only one resolution conversion section 22A, the VF display image processing section 22 of the fourth embodiment has, as shown in FIG. 20, three resolution conversion sections: a first resolution conversion section 22A1, a second resolution conversion section 22A2, and a third resolution conversion section 22A3. The VF display image processing section 22 further includes a changeover section 22D for selectively changing over between the resolution conversion sections under the control (according to the read method setting parameter PR) of the controller 34.

The above first to third resolution conversion sections 22A1, 22A2, and 22A3 are DSPs that compress the read image I_{R} with different resolution conversion algorithms. For example, as in the case of the resolution conversion section 22A in the second embodiment, the first resolution conversion section 22A1 uses a resolution conversion algorithm for calculating one pixel of the display image I_{D} from 2×2 pixels of the read image I_{R}, to create the display image I_{D} of about 2,000,000 pixels from the read image I_{R} of about 8,000,000 pixels. The second resolution conversion section 22A2 uses a resolution conversion algorithm for calculating one pixel of the display image I_{D} from 9×9 pixels of the read image I_{R} that has been read at a resolution of about 4,700,000 pixels to create the display image I_{D} of about 2,000,000 pixels from the read image I_{R} of about 4,700,000 pixels, as shown in FIG. 21. The third resolution conversion section 22A3 uses a resolution conversion algorithm that outputs the read image I_{R} that has been read at a resolution of about 2,000,000 pixels without compressing it to create the display image I_{D} of about 2,000,000 pixels from the read image I_{R} of about 2,000,000 pixels.

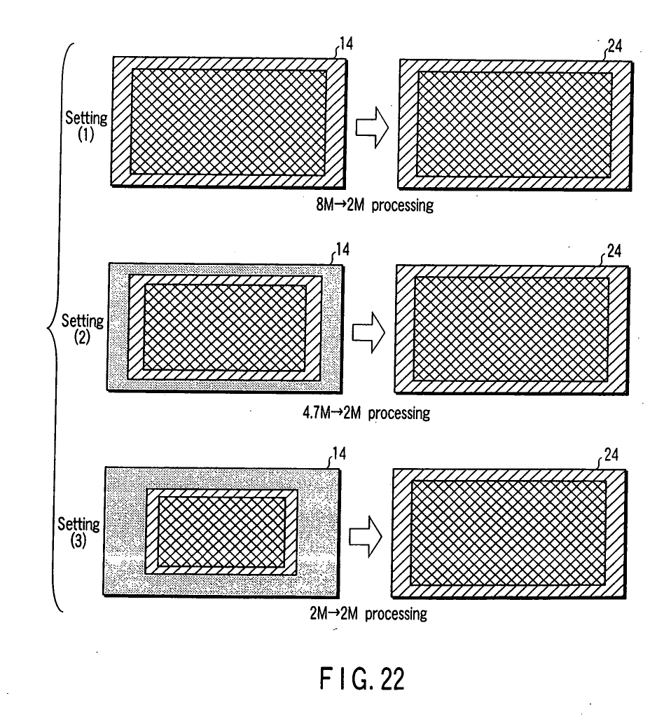

The changeover section 22D selectively changes over between the first to third resolution conversion sections 22A1 to 22A3 according to the read method setting parameter PR from the controller 34 that has been set in the read method setting section 32. As a result, as shown in FIG. 22, the entire area of the display area on the electronic viewfinder 24 is always used as the image display area 28. That is, the entire area of the electronic viewfinder 24 can be utilized to the full.

In this case, however, an image is always fully displayed on the electronic viewfinder 24, so that a camera operator cannot know the resolution of the currently-displayed read image I_{R} (or recording image) in this state. Therefore, it is desirable to display information indicating the current resolution (e.g., information such as “8M” or “4M”) within the display area of the electronic viewfinder 24. This information is preferably located outside the recording area 30 so as not to interfere with the capturing operation.

In the second embodiment, when the number of pixels to be read from the image sensor 14 is reduced, only a part of the display area of the electronic viewfinder 24 is used as the image display area 28, as shown in, e.g., FIG. 16. According to the fourth embodiment, the VF display image processing section 22 has a plurality of resolution conversion sections (algorithms), so that even when the number of pixels to be read from the image sensor 14 is reduced, the entire area of the display area on the electronic viewfinder 24 is used as the image display area 28. That is, the entire area of the electronic viewfinder 24 can be utilized to the full.

While the fourth embodiment is applied to the configuration of the second embodiment in the above description, it is also applicable to the configuration of the third embodiment.

Further, while the VF display image processing section 22 has three resolution conversion sections in the above description, the number of the resolution conversion sections is not limited to this.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An electronic image capturing apparatus comprising:
an image sensor configured to capture a subject image;
a record section configured to record the image center area of the entire image area of an image signal output from the image sensor;
a signal processing section configured to convert the resolution of the entire image area of the image signal output from the image sensor; and
an electronic viewfinder configured to display the resolution-converted image signal output from the signal processing section.

2. The apparatus according to claim 1, wherein
the image sensor is configured to be able to change the size of the read pixel area of an image signal, and
the electronic image capturing apparatus further comprises:
a setting section configured to set the size of the pixel area to be read from the image sensor; and
a controller configured to allow the image sensor to output the image signal according to the pixel area to be read specified in the setting made by the setting section.

3. The apparatus according to claim 2, wherein
the image sensor is further configured to be able to change a frame rate,
the setting section is further configured to set the frame rate of the image sensor, and
the controller is further configured to allow the image sensor to output an image signal according to the frame rate specified in the setting made by the setting section.

4. The apparatus according to claim 3, wherein
the setting section is configured to select the size of the pixel area to be read from the image sensor and frame rate of the image sensor from a plurality of setting values previously determined, respectively.

5. The apparatus according to claim 3, wherein
the signal processing section has a recording image area display section configured to allow the electronic viewfinder to display a range of the image area to be recorded in the record section.

6. The apparatus according to claim 3, wherein
the signal processing section has a conversion section configured to convert the resolution of the entire image area of an image signal that has been output from the image sensor with an identical algorithm irrespective of the setting made in the setting section.

7. The apparatus according to claim 6, wherein
the algorithm includes processing of converting the entire image area of an image signal output from the image sensor such that 2×2 pixels are converted into one pixel.

8. The apparatus according to claim 3, wherein
the signal processing section has a conversion section configured to convert the resolution of the entire image area of an image signal that has been output from the image sensor with different algorithms specified in the setting made in the setting section.

9. The apparatus according to claim 8, wherein
the algorithm includes:
processing of converting the entire image area of an image signal output from the image sensor such that 2×2 pixels are converted into one pixel;
processing of converting the entire image area of an image signal output from the image sensor such that 9×9 pixels are converted into one pixel; and
processing of outputting the entire image area of an image signal output from the image sensor without converting it.

10. The apparatus according to claim 3, further comprising an external output terminal through which a resolution-converted image signal output from the signal processing section is output to an external device.

11. The apparatus according to claim 3, further comprising an external output terminal through which an image signal to be recorded in the record section is output to an external device.

12. The apparatus according to claim 2, wherein
the setting section is configured to select the size of the pixel area to be read from the image sensor from a plurality of setting values previously determined.

13. The apparatus according to claim 2, wherein
the signal processing section has a recording image area display section configured to allow the electronic viewfinder to display a range of the image area to be recorded in the record section.

14. The apparatus according to claim 2, wherein
the signal processing section has a conversion section configured to convert the resolution of the entire image area of an image signal that has been output from the image sensor with an identical algorithm irrespective of the setting made in the setting section.

15. The apparatus according to claim 14, wherein
the algorithm includes processing of converting the entire image area of an image signal output from the image sensor such that 2×2 pixels are converted into one pixel.

16. The apparatus according to claim 2, wherein
the signal processing section has a conversion section configured to convert the resolution of the entire image area of an image signal that has been output from the image sensor with different algorithms specified in the setting made in the setting section.

17. The apparatus according to claim 16, wherein
the algorithm includes:
processing of converting the entire image area of an image signal output from the image sensor such that 2×2 pixels are converted into one pixel;
processing of converting the entire image area of an image signal output from the image sensor such that 9×9 pixels are converted into one pixel; and
processing of outputting the entire image area of an image signal output from the image sensor without converting it.

18. The apparatus according to claim 2, further comprising an external output terminal through which a resolution-converted image signal output from the signal processing section is output to an external device.

19. The apparatus according to claim 2, further comprising an external output terminal through which an image signal to be recorded in the record section is output to an external device.

20. The apparatus according to claim 1, wherein
the signal processing section has a recording image area display section configured to allow the electronic viewfinder to display a range of the image area to be recorded in the record section.

21. The apparatus according to claim 1, further comprising an external output terminal through which a resolution-converted image signal output from the signal processing section is output to an external device.

22. The apparatus according to claim 1, further comprising an external output terminal through which an image signal to be recorded in the record section is output to an external device.

23. A control method of an electronic image capturing apparatus comprising:
recording the image center area of the entire image area of an image signal output from an image sensor configured to capture a subject image in a recording medium;
converting the resolution of the entire image area of the image signal output from the image sensor; and
displaying the resolution-converted image signal on an electronic viewfinder.

24. The method according to claim 23, wherein
in the case where the image sensor is an image sensor that can change the size of the read pixel area of an image signal,
the method comprises: setting the size of the pixel area to be read from the image sensor; and
outputting the image signal from the image sensor according to the pixel area to be read specified in the setting.

25. The method according to claim 24, wherein
in the case where the image sensor is an image sensor that can further change a frame rate,
the method comprises: setting the frame rate of the image sensor as well as the size of the pixel area to be read from the image sensor; and
outputting an image signal from the image sensor according to the read area and frame rate specified in the setting.

26. An image processing apparatus comprising:
a recording image signal creation section configured to receive an image signal output from an image sensor configured to capture a subject image and output the image center area of the entire image area of the image signal as a recording image signal; and
a display image signal creation section configured to receive an image signal output from the image sensor and convert the resolution of the entire image area of the image signal so as to output it as a display image signal.

27. The apparatus according to claim 26, wherein
in the case where the image sensor is an image sensor that can change the size of the readout pixel area of an image signal so as to output the image signal,
the image processing apparatus further comprises:
a setting section configured to set the size of the pixel area to be read from the image sensor; and
a controller configured to output the image signal from the image sensor according to the pixel area to be read specified in the setting made by the setting section.

28. The apparatus according to claim 27, wherein
in the case where the image sensor is an image sensor that can further change a frame rate,
the setting section is further configured to set the frame rate of the image sensor, and
the controller is further configured to allow the image sensor to output an image signal according to the frame rate specified in the setting made by the setting section.

29. An electronic image capturing apparatus comprising:
an image sensor for capturing a subject image;
record means for recording the image center area of the entire image area of an image signal output from the image sensor;
signal processing means for converting the resolution of the entire image area of the image signal output from the image sensor; and
an electronic viewfinder for displaying the resolution-converted image signal output from the signal processing means.

30. A control method of an electronic image capturing apparatus comprising:
a step of recording the image center area of the entire image area of an image signal output from an image sensor configured to capture a subject image in a recording medium;
a step of converting the resolution of the entire image area of the image signal output from the image sensor; and
a step of displaying the resolution-converted image signal on an electronic viewfinder.

31. An image processing apparatus comprising:
recording image signal creation means for receiving an image signal output from an image sensor configured to capture a subject image and outputting the image center area of the entire image area of the image signal as a recording image signal; and
display image signal creation means for receiving an image signal output from the image sensor and converting the resolution of the entire image area of the image signal so as to output it as a display image signal.
